(19) United States
(12) Patent Application Publication
(10) Pub. No.: US 2023/0003583 A1
(43) Pub. Date: Jan. 5, 2023

(54) SIGNAL PROCESSING DEVICE, SIGNAL PROCESSING METHOD, AND PROGRAM

(71) Applicant: SONY GROUP CORPORATION, TOKYO (JP)

(72) Inventors: LEGONG SUN, TOKYO (JP); YASUTAKA HIRASAWA, TOKYO (JP); YUHI KONDO, TOKYO (JP); TAISHI ONO, TOKYO (JP)

(21) Appl. No.: 17/756,940

(22) PCT Filed: Nov. 30, 2020
(86) PCT No.: PCT/JP2020/044461

§ 371 Date: Jun. 6, 2022

(30) Foreign Application Priority Data
Dec. 17, 2019 (JP) 2019-227285

(51) Int. Cl. G01J 4/04; G01N 21/21

(52) U.S. Cl. CPC G01J 4/04; G01N 21/21

(57) ABSTRACT

A quantization range setting unit (31) of an encoder (30) sets a quantization range for each Stokes parameter of a Stokes vector acquired from a Stokes vector calculation unit (20). The quantization range is set for the Stokes parameter indicating intensity, and is then set for the other Stokes parameters. A quantization unit (32) calculates the Stokes parameter indicating intensity as a predetermined quantization bit number, and calculates the quantization bit numbers of the other Stokes parameters on the basis of the predetermined quantization bit number and the quantization ranges set for the respective Stokes parameters. The quantization unit (32) performs a quantization process on the Stokes parameters on the basis of the quantization ranges and the quantization bit numbers, to generate quantized polarization information. A decoder (40) performs inverse quantization compatible with the encoder 30 on the quantized polarization information, and generates the Stokes vectors before quantization. The amount of polarization information data can be reduced.

### TECHNICAL FIELD

This technology relates to a signal processing device, a signal processing method, and a program, and is to enable reduction of the data amount of polarization information.

### BACKGROUND ART

Conventionally, in the fields using polarization states of light, a Stokes vector is acquired as information indicating polarization characteristics, as disclosed in Patent Document 1.

### CITATION LIST

### Patent Document

Patent Document 1: Japanese Patent Application Laid-Open No. 2018-194455

### SUMMARY OF THE INVENTION

### Problems to be Solved by the Invention

Meanwhile, to record or transmit acquired polarization information, the data amount is preferably small.

Therefore, this technology aims to provide a signal processing device, a signal processing method, and a program capable of reducing the data amount of polarization information.

### Solutions to Problems

A first aspect of this technology lies in

a signal processing device that includes

a processing unit that performs a quantization process on a Stokes parameter or an inverse quantization process on the Stokes parameter quantized, on the basis of a quantization range set for each Stokes parameter in accordance with a constraint condition regarding the Stokes parameter and a quantization bit number calculated for each Stokes parameter in accordance with the set quantization range.

In this technology, the quantization range setting unit sets the quantization range for each Stokes parameter, on the basis of constraint conditions regarding the Stokes parameters. The quantization range is set for the Stokes parameter indicating intensity, and is then set for the other Stokes parameters. Further, the quantization ranges of the other Stokes parameters may be set in descending order of value. Also, the quantization range of the Stokes parameter indicating a difference in circularly polarized light may be set after the other Stokes parameters.

The processing unit calculates the Stokes parameter indicating intensity as a predetermined quantization bit number, and calculates the quantization bit numbers of the other Stokes parameters on the basis of the predetermined quantization bit number and the quantization ranges set for the respective Stokes parameters. The processing unit also performs a quantization process on the Stokes parameters or an inverse quantization process on the quantized Stokes parameters, on the basis of the quantization ranges and the quantization bit numbers. Further, the processing unit may calculate a resolution increase rate on the basis of the compression rate indicating the ratio of the quantization bit number to the predetermined quantization bit number, and expand the quantization bit number of each Stokes parameter with the resolution increase rate.

In a case where a quantization process is performed on the Stokes parameters, the processing unit generates quantized polarization information as the quantization bit number of each Stokes parameter according to the quantization ranges set by the quantization range setting unit or the quantization bit number expanded at the resolution increase rate. Also, in a case where the quantized polarization information is returned to the Stokes parameters before the quantization process, the processing unit sets the quantization ranges of the other Stokes parameters on the basis of the Stokes parameters obtained by performing an inverse quantization process on the quantized polarization information, and performs an inverse quantization process on the other Stokes parameters, using the set quantization ranges. Further, the resolution increase rate is calculated from the quantized polarization information, and the inverse quantization process is performed on the Stokes parameters, using the calculated resolution increase rate.

A second aspect of this technology lies in

a signal processing method that includes

performing a quantization process on a Stokes parameter or an inverse quantization process on the Stokes parameter quantized, on the basis of a quantization range set for each Stokes parameter in accordance with a constraint condition regarding the Stokes parameter and a quantization bit number calculated for each Stokes parameter in accordance with the set quantization range, the quantization process or the inverse quantization process being performed by a processing unit.

A third aspect of this technology lies in

a program for causing a computer to perform a quantization process or an inverse quantization process on a Stokes parameter,

the program causing the computer to carry out:

the step of setting a quantization range for each Stokes parameter on the basis of a constraint condition regarding the Stokes parameter;

the step of calculating a quantization bit number for each Stokes parameter in accordance with the set quantization range; and

the step of performing a quantization process on the Stokes parameter, or an inverse quantization process on the Stokes parameter quantized, on the basis of the quantization range and the quantization bit number.

Note that the program according to the present technology is a program that can be provided to a general-purpose computer capable of executing various program codes, for example, by a storage medium provided in a computer-readable format, a communication medium, a storage medium such as an optical disk, a magnetic disk, or a semiconductor memory, for example, or a communication medium such as a network, for example. As such a program is provided in a computer-readable format, processes according to the program are performed in a computer.

### BRIEF DESCRIPTION OF DRAWINGS

FIG. 1 is a diagram for explaining a Stokes vector.

FIG. 2 is a diagram showing an example configuration of a system.

FIG. 3 is a flowchart showing an operation of an encoder.

FIG. 4 is a flowchart showing a first quantization range setting operation.

FIG. 5 is a diagram showing an example of the quantization ranges set in the first setting operation.

FIG. 6 is a flowchart showing a second quantization range setting operation.

FIG. 7 is a diagram showing an example of the quantization ranges set in the second setting operation.

FIG. 8 is a flowchart showing a third quantization range setting operation.

FIG. 9 is a diagram showing an example of the quantization ranges set in the third setting operation.

FIG. 10 is a flowchart showing a first quantization operation.

FIG. 11 is a diagram showing the first quantization operation, along with a conventional operation.

FIG. 12 is a flowchart showing a second quantization operation.

FIG. 13 is a diagram showing the second quantization operation, along with a conventional operation.

FIG. 14 is a flowchart showing an operation of a decoder.

### MODE FOR CARRYING OUT THE INVENTION

The following is a description of modes for carrying out the present technology. Note that explanation will be made in the following order.

1. Stokes vector and its constraint conditions

2. Signal processing device
2-1. Configuration of the signal processing device
2-2. Operation of an encoder
2-3. Quantization range setting operation in the signal processing device
2-4. Quantization operation in the signal processing device
2-5. Operation of a Decoder
2-6. Other configurations and operations

3. Example applications

### 1. Stokes Vector and its Constraint Conditions

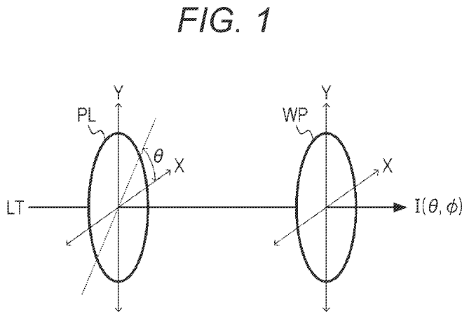

FIG. 1 is a diagram for explaining a Stokes vector. A light beam LT emitted from a light source is observed through a linearly polarizing plate (polarization angle θ) PL and a wave plate (phase shift φ) WP, to obtain observation luminance I (θ, φ). Here, the observation luminance of 0° polarized light (θ=0°, φ=0°) is set as “I0°”. Also, the observation luminance of 45° polarized light (θ=45°, φ=0°) is set as “I45°”, the observation luminance of 90° polarized light (θ=90°, φ=0°) is set as “I90°”, and the observation luminance of 135° polarized light (θ=135°, φ=0°) is set as “I135°”. Further, the observation luminance of right circularly polarized light (θ=45°, φ=−90°) is set as “IR”, and the observation luminance of left circularly polarized light (θ=45°, φ=90°) is set as “IL”. In this case, the observed Stokes vector S is as shown in Expression (1). A Stokes parameter S0 is a sum of the observation luminance of the 0-degree polarized light and the observation luminance of the 90-degree polarized light, and is a parameter indicating intensity. A Stokes parameter S1 indicates a difference between the observation luminance of the 0-degree polarized light and the observation luminance of the 90-degree polarized light, a Stokes parameter S2 indicates a difference between the observation luminance of the 45-degree polarized light and the observation luminance of the 135-degree polarized light, and a Stokes parameter S3 indicates a difference between the observation luminance IR of the right circularly polarized light and the observation luminance IL of the left circularly polarized light.

$$\begin{matrix}[ Mathematical Expression 1 ] & \\ S = [ \begin{matrix}{S}_{0} \\ {S}_{1} \\ {S}_{2} \\ {S}_{3}\end{matrix} ] = [ \begin{matrix}{I}_{0 °} + {I}_{90 °} \\ {I}_{0 °} - {I}_{90 °} \\ {I}_{45 °} + {I}_{135} \\ {I}_{R} - {I}_{L}\end{matrix} ] & ( 1 )\end{matrix}$$

Each Stokes parameter of the Stokes vector S is not an independent parameter, and there are physical and mutual constraints. For example, a polarization degree p is defined as shown in Expression (2). Further, according to Expression (2), the constraint conditions shown in Expressions (3) to (6) are satisfied.

$$\begin{matrix}[ Mathematical Expression 2 ] & \\ ρ = \frac{\sqrt{{S}_{1}^{2} + {S}_{2}^{2} + {S}_{3}^{2}}}{{S}_{0}} ∈ [ 0 , 1 ] & ( 2 )\end{matrix}$$

$${S}_{0} \geq \vert {S}_{1} \vert , {S}_{0} \geq \vert {S}_{2} \vert , {S}_{0} \geq \vert {S}_{3} \vert \qquad ( 3 )$$

$$\sqrt{{S}_{0}^{2} - {S}_{2}^{2}} \geq \sqrt{{S}_{0}^{2} - {S}_{2}^{2} - {S}_{3}^{2}} \geq \vert {S}_{1} \vert \qquad ( 4 )$$

$$\sqrt{{S}_{0}^{2} - {S}_{1}^{2}} \geq \sqrt{{S}_{0}^{2} - {S}_{1}^{2} - {S}_{3}^{2}} \geq \vert {S}_{2} \vert \qquad ( 5 )$$

$$\sqrt{{S}_{0}^{2} - {S}_{1}^{2}} \geq \sqrt{{S}_{0}^{2} - {S}_{1}^{2} - {S}_{2}^{2}} \geq \vert {S}_{3} \vert \qquad ( 6 )$$

Further, it is known that the polarization degree p is defined as shown in Expression (7), and the relationship among the maximum observation luminance Imax, the minimum observation luminance Imin, and the Stokes parameter S0 is as shown in Expression (8) and Expression (9).

$$\begin{matrix}[ Mathematical Expression 3 ] & \\ ρ = \frac{{I}_{max} - {I}_{min}}{{I}_{max} + {I}_{min}} ∈ [ 0 , 1 ] & ( 7 )\end{matrix}$$

$${S}_{0} = {I}_{max} + {I}_{min} \qquad ( 8 )$$

$${I}_{min} = {S}_{0} - {I}_{max} \qquad ( 9 )$$

That is, since the polarization degree ρ has the relationship shown in Expression (10), the absolute value of the Stokes parameter S1 is constrained as shown in Expression (11). Further, where the luminance of the light beam LT is “1”, the maximum observation luminance is expressed as “0≤Imax≤1”, and accordingly, Expression (11) can be expressed as Expression (12).

$$\begin{matrix}[ Mathematical Expression 4 ] & \\ ρ = \frac{{I}_{max} - {I}_{min}}{{I}_{max} + {I}_{min}} = \frac{{I}_{max} - ( {S}_{0} - {I}_{max} )}{{S}_{0}} = \frac{2 {I}_{max} - {S}_{0}}{{S}_{0}} = \frac{\sqrt{{S}_{1}^{2} + {S}_{2}^{2} + {S}_{3}^{2}}}{{S}_{0}} \geq \frac{\sqrt{{S}_{1}^{2}}}{{S}_{0}} = \frac{\vert {S}_{1} \vert}{{S}_{0}} & ( 10 )\end{matrix}$$

$$2 {I}_{max} - {S}_{0} \geq \vert {S}_{1} \vert \qquad ( 11 )$$

$$2 - {S}_{0} \geq 2 {I}_{max} - {S}_{0} \geq \vert {S}_{1} \vert \qquad ( 12 )$$

Further, the same applies to the Stokes parameters S2 and S3, and the absolute values of the Stokes parameters S1, S2, and S3 are constrained as shown in Expression (13).

[Mathematical Expression 5]

2−S₀≥|S₁|,2−S₀≥|S₂|,2−S₀≥|S₃| (13)

From the above constraints, the possible range (quantization range) of the Stokes parameter S0 is within the range of “0 to 2”. Further, in a case where the quantization range Rₐ of the Stokes parameter S1 is set to the range of “±a” (note that, in the present technology, “a”, and “b” and “c” described later are range values), when the Stokes parameter S0 is known, the range value a of the Stokes parameter S1 is the value shown in Expression (14). Also, when the Stokes parameters S0 and S2 are known, the range value a is the value shown in Expression (15). When the Stokes parameters S0, S2, and S3 are known, the range value a is the value shown in Expression (16). Note that, in the range value calculation formula, the function min means selecting the minimum value of the elements in parentheses.

[Mathematical Expression 6]

a=min(S₀,2−S₀) (14)

a=min(S₀,2−S₀,\sqrt{S₀²−S₂²}) (15)

a=min(S₀,2−S₀,\sqrt{S₀²−S₂²−S₃³}) (16)

Likewise, in a case where the quantization range R_{b} of the Stokes parameter S2 is set to the range of “±b”, when the Stokes parameter S0 is known, the range value b of the Stokes parameter S2 is the value shown in Expression (17). Also, when the Stokes parameters S0 and S1 are known, the range value b is the value shown in Expression (18). When the Stokes parameters S0, S1, and S3 are known, the range value b is the value shown in Expression (19).

[Mathematical Expression 7]

b=min(S₀,2−S₀) (17)

b=min(S₀,2−S₀,\sqrt{S₀²−S₁²}) (18)

b=min(S₀,2−S₀,\sqrt{S₀²−S₁²−S₃²}) (19)

Further, in a case where the quantization range R₀ of the Stokes parameter S3 is set to the range of “±c”, when the Stokes parameter S0 is known, the range value c of the Stokes parameter S3 is the value shown in Expression (20). Also, when the Stokes parameters S0 and S1 are known, the range value c is the value shown in Expression (21). When the Stokes parameters S0, S1, and S2 are known, the range value c is the value shown in Expression (22).

[Mathematical Expression 8]

c=min(S₀,2−S₀) (20)

c=min(S₀,2−S₀,\sqrt{S₀²−S₁²}) (21)

c=min(S₀,2−S₀,\sqrt{S₀²−S₁²−S₂²}) (22)

### 2. Signal Processing Device

A signal processing device according to the present technology quantizes polarization information indicating a Stokes vector and inversely quantizes the quantized information, using the constraint conditions described above.

### [2-1. Configuration of a Signal Processing Device]

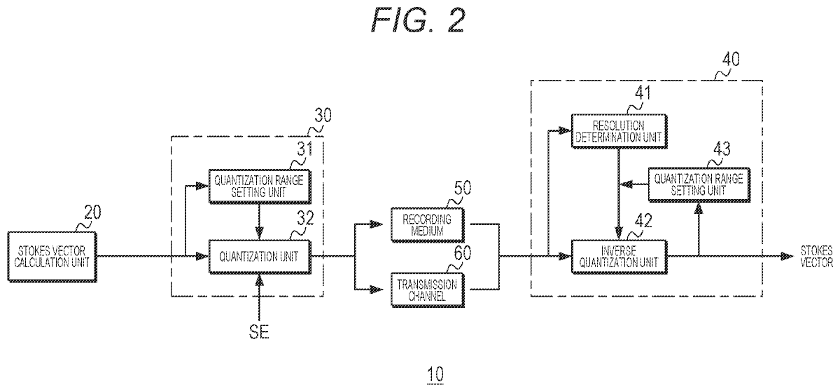

FIG. 2 shows an example configuration of a system using a signal processing device according to the present technology. A system 10 includes a Stokes vector calculation unit 20, an encoder 30 that quantizes polarization information indicating a Stokes vector and generates quantized polarization information, and a decoder 40 that decompresses the quantized polarization information and generates polarization information prior to quantization. The quantized polarization information is also supplied from the encoder 30 to the decoder 40 via a recording medium 50 or a transmission channel 60.

The Stokes vector calculation unit 20 acquires observation luminances I0°, I45°, I90°, and I135°, and observation luminances IR and IL from a polarization imaging unit (not shown), calculates a Stokes vector S, and outputs the Stokes vector S to the encoder 30. The polarization imaging unit does not include any color filter, for example, and generates signals indicating the observation luminances I0°, I45°, I90°, and I135° and observation luminances IR and IL, using an imaging element, a linearly polarizing plate, and a wave plate.

The encoder 30 includes a quantization range setting unit 31 and a quantization unit (also referred to as a processing unit) 32. The quantization range setting unit 31 sets the quantization ranges of the Stokes parameter S0, the Stokes parameter S1, the Stokes parameter S2, and the Stokes parameter S3, on the basis of the above-mentioned constraint conditions Stokes parameters.

The quantization unit 32 performs a quantization process on the Stokes parameters, on the basis of the quantization bit number calculated for each Stokes parameter in accordance with the quantization ranges set by the quantization range setting unit on the basis of the constraint conditions regarding the Stokes parameters, and thus, generates the quantized polarization information. In generating the quantized polarization information, the quantization unit 32 also performs either quantization for the purpose of reducing the data amount or quantization for the purpose of enhancing resolution, for example. Which one of the quantization for the purpose of reducing the data amount and the quantization for the purpose of enhancing resolution is to be performed may be designated in advance, or may be selected from the outside with a quantization select signal SE. Further, which quantization is to be used may be automatically selected in accordance with the purpose of use of the polarization information and the device to use the polarization information. The quantized polarization information generated by the quantization unit 32 is output to the decoder 40 via the recording medium 50 or the transmission channel 60.

The decoder 40 performs inverse quantization compatible with the quantization performed by the encoder 30, on the quantized polarization information acquired via the recording medium 50 or the transmission channel 60, and generates the polarization information prior to the data compression. The decoder 40 includes an inverse quantization unit (also referred to as a processing unit) 42 and a quantization range setting unit 43. In a case where the decoder 40 performs an inverse quantization process on the quantized polarization information generated through the quantization for the purpose of enhancing resolution, the decoder 40 may also include a resolution determination unit 41.

In a case where it is determined that the quantized polarization information is generated through the quantization for the purpose of enhancing resolution, the resolution determination unit 41 calculates a resolution increase rate 3, and outputs the resolution increase rate 3 to the inverse quantization unit 42.

The inverse quantization unit 42 inversely quantizes the quantized polarization information, using the resolution increase rate calculated by the resolution determination unit 41 and the quantization ranges set by the quantization range setting unit 43 described later. Alternatively, in a case where the quantized polarization information is generated through the quantization for the purpose of reducing the data amount, the inverse quantization unit 42 inversely quantizes the quantized polarization information, using the quantization ranges set by the quantization range setting unit 43. The inverse quantization unit 42 outputs the obtained Stokes parameters to the quantization range setting unit 43 and to the outside.

On the basis of the Stokes parameters output from the inverse quantization unit 42, the quantization range setting unit 43 sets the quantization ranges to be used for the inverse quantization that follows. The quantization range setting unit 43 outputs the set quantization ranges to the inverse quantization unit 42.

### <2-2. Operation of the Encoder>

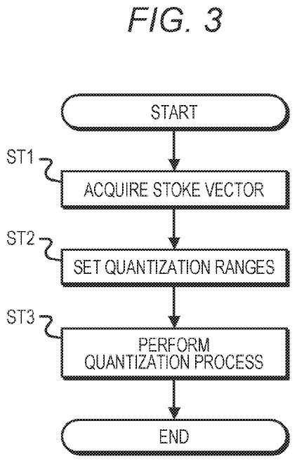

FIG. 3 is a flowchart showing an operation of the encoder. In step ST1, the encoder acquires a Stokes vector. The encoder 30 acquires the Stokes vector calculated by the Stokes vector calculation unit 20, and then moves on to step ST2.

In step ST2, the encoder sets quantization ranges. As for the respective Stokes parameter of the Stokes vector, after setting the quantization range for the Stokes parameter indicating intensity, the quantization range setting unit 31 of the encoder 30 sets the quantization ranges for the other Stokes parameters, and moves on to step ST3. Note that the setting of the quantization ranges will be described later in detail.

In step ST3, the encoder performs a quantization process. The quantization unit 32 of the encoder 30 quantizes the respective Stokes parameters of the Stokes vector in the quantization ranges set in step ST2, to generate quantized polarization information.

### <2-3. Quantization Range Setting Operation in the Signal Processing Device>

In a first quantization range setting operation, quantization ranges are set in the order of the Stokes parameters S0, S1, S2, and S3.

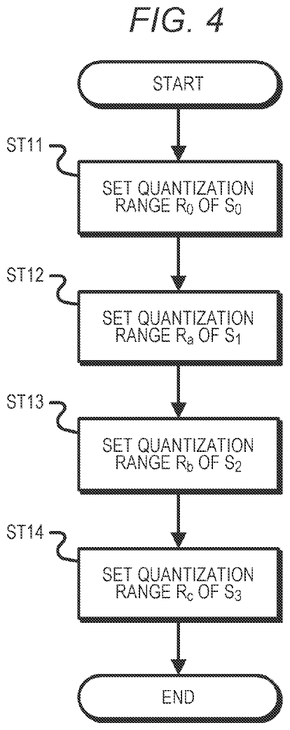

FIG. 4 is a flowchart showing a first quantization range setting operation. In step ST11, the quantization range setting unit sets the quantization range R₀ of the Stokes parameter S0 to “0 to 2”. The quantization range setting unit 31 sets the quantization range R₀ of the Stokes parameter S0 to “0 to 2” as described above, and then moves on to step ST12.

In step ST12, the quantization range setting unit sets the quantization range Rₐ of the Stokes parameter S1. Since there are constraints shown in Expressions (3) and (12), the quantization range setting unit 31 calculates a range value a on the basis of Expression (14), sets the quantization range Rₐ (=±a), and then moves on to step ST13.

In step ST13, the quantization range setting unit sets the quantization range Rb of the Stokes parameter S2. Since the quantization range and the range value a of the Stokes parameter S0 are set, the quantization range setting unit 31 calculates a range value b on the basis of Expression (18), sets the quantization range R_{b} (±b), and then moves on to step ST14.

In step ST14, the quantization range setting unit sets the quantization range R_{c} of the Stokes parameter S3. Since the quantization range of the Stokes parameter S0, the range value a of the Stokes parameter 51, and the range value b of the Stokes parameter S2 are set, the quantization range setting unit 31 calculates a range value c on the basis of Expression (22), and sets the quantization range R₀ (=±c).

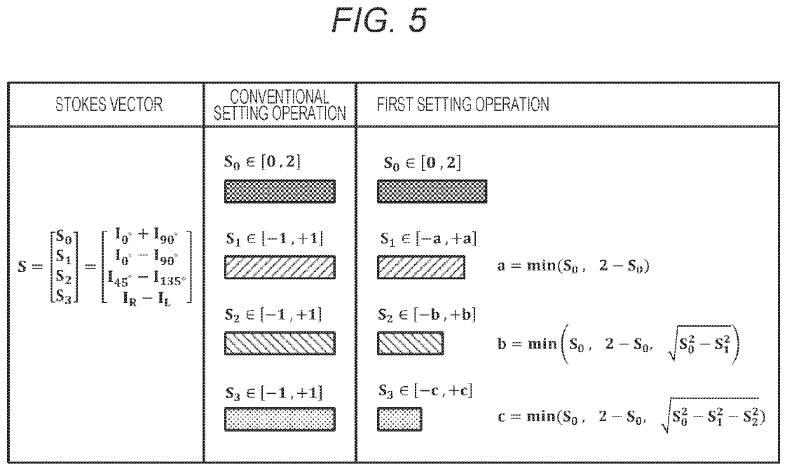

FIG. 5 shows an example of the quantization ranges set in the first setting operation. In a conventional quantization range setting operation, the same quantization ranges (the absolute value being “2”) are assigned to the Stokes parameters S₀, S₁, S₂, and S₃ of the Stokes vector. However, according to the first quantization range setting operation, quantization ranges are sequentially set for the Stokes parameters S0, S1, S2, and S3, and the quantization range of the next Stokes parameter is set on the basis of another Stokes parameter for which the quantization range has already been set. Thus, the quantization ranges can be set more efficiently than in the conventional operation.

In a second quantization range setting operation, quantization ranges are set in descending order of values of the Stokes parameters S1, S2, and S3, following the Stokes parameter S0.

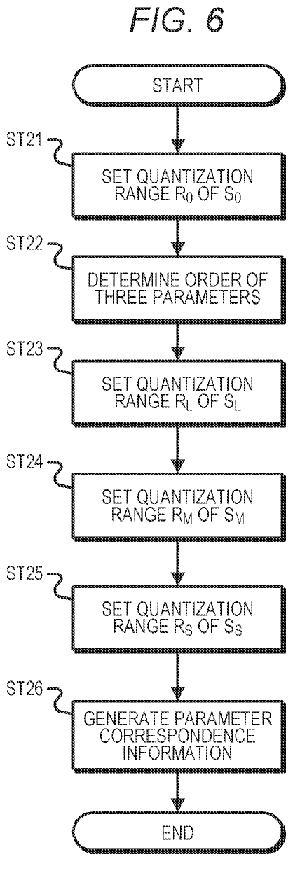

FIG. 6 is a flowchart showing a second quantization range setting operation. In step ST21, the quantization range setting unit sets the quantization range R₀ of the Stokes parameter S0. The quantization range setting unit 31 sets the quantization range R₀ of the Stokes parameter S0 to “0 to 2” as described above, and then moves on to step ST22.

In step ST22, the quantization range setting unit performs three-parameter order determination. The quantization range setting unit 31 sets the Stokes parameter having the largest value among the Stokes parameters S1, S2, and S3 as a parameter SL, the Stokes parameter having the smallest value as a parameter SS, and the Stokes parameter having a value smaller than the parameter SL and larger than the parameter SS as a parameter SM. Note that, in a case where there is a plurality of Stokes parameters having the same value, the order is set according to a preset rule. The quantization range setting unit 31 sets the parameters SL, SM, and SS, and moves on to step ST23.

In step ST23, the quantization range setting unit sets the quantization range R_{L} of the parameter SL. The quantization range setting unit 31 replaces the Stokes parameter S1 in Expressions (12) and (14) with the parameter SL, for example, calculates the range value a of the parameter SL on the basis of Expression (14), sets the quantization range R_{L} (±a), and then moves on to step ST24.

In step ST24, the quantization range setting unit sets the quantization range R_{M} of the parameter SM. Since the quantization range of the Stokes parameter S0 and the range value a of the Stokes parameter S1 have been calculated, the quantization range setting unit 31 replaces the Stokes parameter S1 in Expression (18) with the parameter SL, for example, calculates the range value b of the parameter SM on the basis of Expression (18), sets the quantization range R_{M} (±b), and then moves on to step ST25.

In step ST25, the quantization range setting unit sets the quantization range R_{c} of the parameter SS. Since the quantization range of the Stokes parameter S0, the range value a of the Stokes parameter 51, and the range value b of the Stokes parameter S2 have been calculated, the quantization range setting unit 31 replaces the Stokes parameter S2 in Expression (22) with the parameter SM, for example, calculates the range value c of the parameter SS on the basis of Expression (22), and sets the quantization range R_{c} (=±c).

In step ST26, the quantization range setting unit generates parameter correspondence information. The quantization range setting unit 31 generates parameter correspondence information indicating the correspondence relationship between the Stokes parameters S1, S2, and S3 and the parameters SL, SM, and SS, on the basis of the result of the order determination in step ST22.

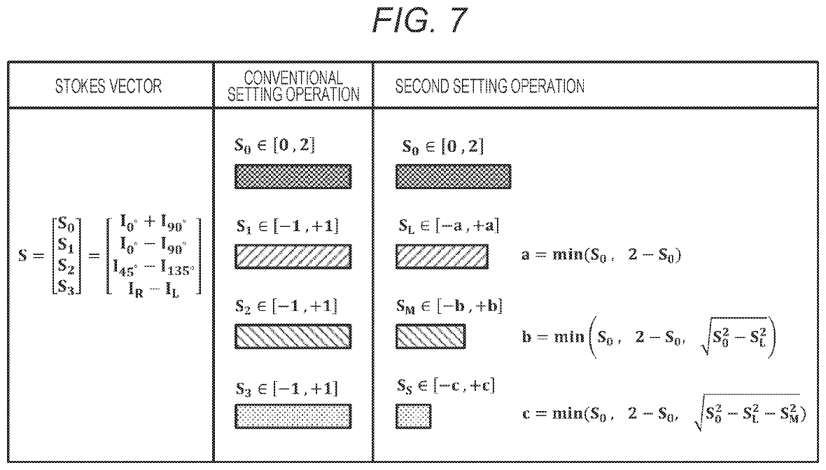

FIG. 7 shows an example of the quantization ranges set in the second setting operation. In a conventional quantization range setting operation, the same quantization ranges (the absolute value being “2”) are assigned to the Stokes parameters S₀, S₁, S₂, and S₃. However, according to the second quantization range setting operation, quantization ranges are sequentially set for the Stokes parameters S1, S2, and S3 in descending order of value, and the quantization range of a smaller Stokes parameter is set on the basis of another Stokes parameter for which the quantization range has already been set. Thus, the quantization ranges can be set more efficiently than in the conventional operation and the first setting operation. Note that FIG. 7 illustrates an example case where S₁>S₂>S₃.

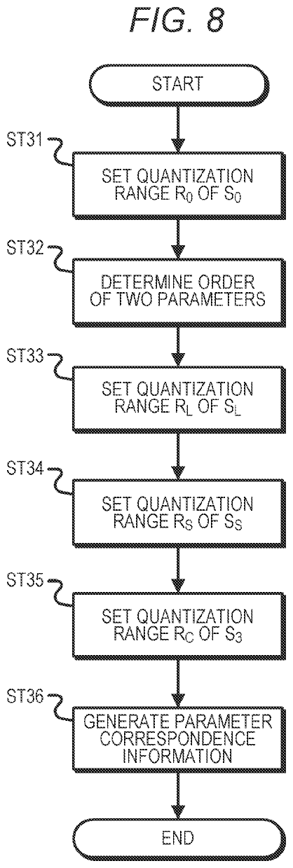

In a third quantization range setting operation, the quantization range of the Stokes parameter S3 indicating the difference in circularly polarized light is set after the other Stokes parameters. FIG. 8 is a flowchart showing a third quantization range setting operation. In step ST31, the quantization range setting unit sets the quantization range R₀ of the Stokes parameter S0. The quantization range setting unit 31 sets the quantization range R₀ of the Stokes parameter S0 to “0 to 2”, and then moves on to step ST32.

In step ST32, the quantization range setting unit performs two-parameter order determination. The quantization range setting unit 31 sets a parameter SL having the larger value and a parameter SS having the smaller value for the Stokes parameters S1 and S2. Note that, in a case where the Stokes parameters S1 and S2 are equal, the order is set according to a preset rule. The quantization range setting unit 31 sets the parameters SL and SS, and then moves on to step ST33.

In step ST33, the quantization range setting unit sets the quantization range R_{L} of the parameter SL. The quantization range setting unit 31 replaces the Stokes parameter S1 in Expressions (12) and (14) with the parameter SL, for example, calculates the range value a of the parameter SL on the basis of Expression (14), sets the quantization range R_{L} (=±a), and then moves on to step ST34.

In step ST34, the quantization range setting unit sets the quantization range R_{S} of the parameter SS. Since the quantization range of the Stokes parameter S0 and the range value a of the Stokes parameter S1 have been calculated, the quantization range setting unit 31 replaces the Stokes parameter S1 in Expression (18) with the parameter SL, for example, calculates the range value b of the parameter SS on the basis of Expression (18), sets the quantization range R_{S} (=±b), and then moves on to step ST35.

In step ST35, the quantization range setting unit sets the quantization range R_{c} of the Stokes parameter S3. Since the quantization range of the Stokes parameter S0, the range value a of the parameter SL, and the range value b of the parameter SS have been calculated, the quantization range setting unit 31 calculates a range value c on the basis of Expression (22), sets the quantization range R_{c} (=±c), and then moves on to step ST36.

In step ST36, the quantization range setting unit generates parameter correspondence information. The quantization range setting unit 31 generates Stokes parameter correspondence information indicating the correspondence relationship between the Stokes parameters S1 and S2, and the parameters SL and SS, on the basis of the result of the parameter order determination in step ST32.

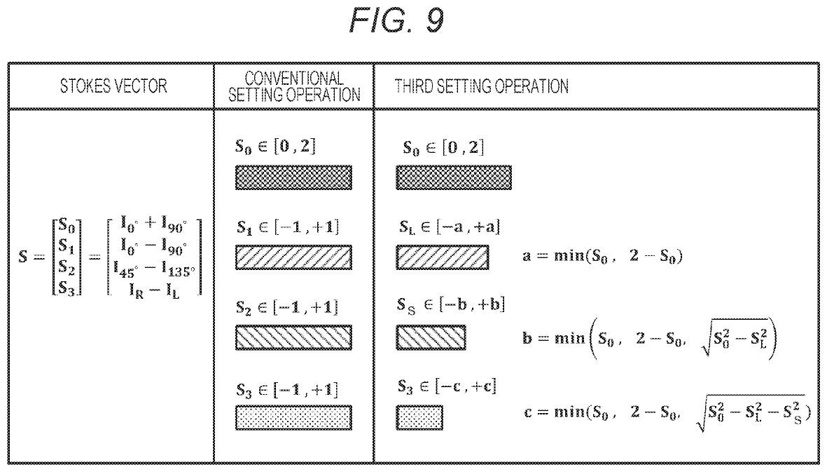

FIG. 9 shows an example of the quantization ranges set in the third setting operation. In a conventional quantization range setting operation, the same quantization ranges (the absolute value being “2”) are assigned to the Stokes parameters S₀, S₁, S₂, and S₃. However, according to the second quantization range setting operation, quantization ranges are set in descending order of the Stokes parameters S1 and S2, and the quantization range of the Stokes parameter S3 is then set. Thus, the quantization ranges can be allocated, with emphasis on the Stokes parameters related to the linear polarization rather than the Stokes parameter related to circularly polarized light. Note that FIG. 9 illustrates an example case where S₁>S₂.

### <2-4. Quantization Operation in the Signal Processing Device>

In a first quantization operation, quantization is performed, with priority given to reduction of the data amount rather than enhancement of resolution. Specifically, the Stokes parameter indicating the intensity is designed to have a predetermined quantization bit number, and the quantization bit numbers of the other Stokes parameters are calculated on the basis of the predetermined quantization bit number and the quantization ranges set for the respective Stokes parameters.

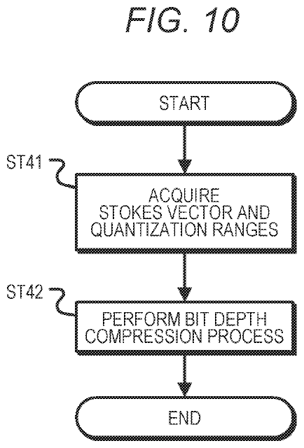

FIG. 10 is a flowchart showing a first quantization operation. In step ST41, the quantization unit acquires a Stokes vector and its quantization ranges. The quantization unit 32 acquires a Stokes vector from the Stokes vector calculation unit 20, and the quantization ranges from the quantization range setting unit 31, and then moves on to step ST42.

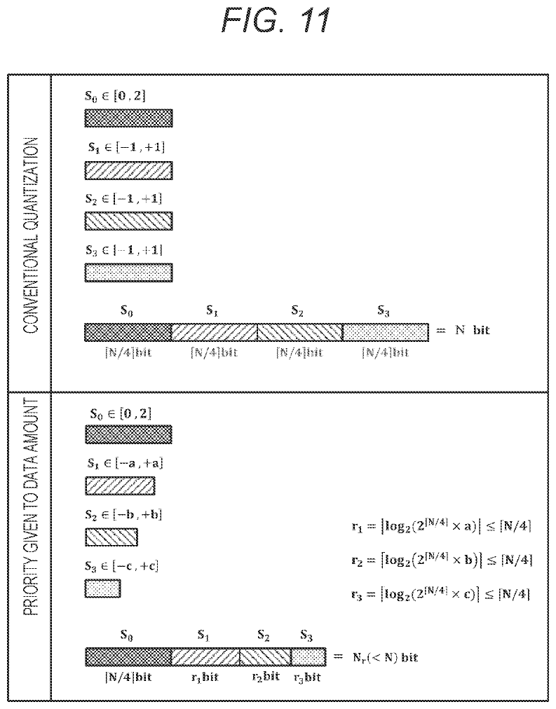

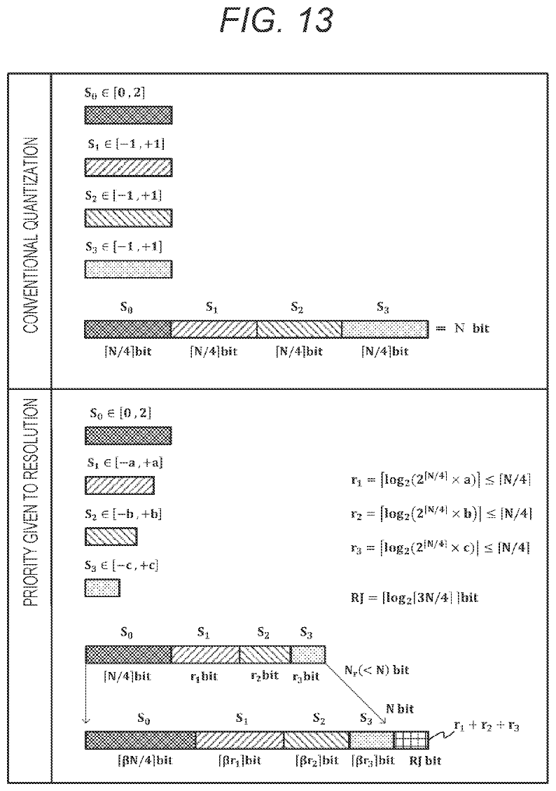

In step ST42, the quantization unit performs a bit number compression process. The quantization unit 32 quantizes the Stokes parameter S0 on the basis of Expression (23), to generate a quantized parameter QS0. Using the range values a, b, and c of the quantization ranges set by the quantization range setting unit 31, the quantization unit 32 also quantizes the Stokes parameters S1, S2, and S3 on the basis of Expressions (24), (25), and (26), to generate quantized parameters QS1, QS2, and QS3. Note that, in Expression (24), the range value a is added to the Stokes parameter S1, to perform processing so that the value to be quantized does not become a negative value. Likewise, the range value b is added to the Stokes parameter S2 in Expression (25), and the range value c is added to the Stokes parameter S3 in Expression (26), to perform processing so that the values to be quantized does not become negative values. Note that Expression (27) shows a calculation formula of a compression rate r, and represents a case where the number of bits to be allocated to the quantized polarization information indicating a Stokes parameter is “N bits”, the compression rate of the Stokes parameter S1 (the ratio of the number of bits after quantization to the number of bits before quantization) is “r1”, the compression rate of the Stokes parameter S2 is “r2”, and the compression rate of the Stokes parameter S3 is “r3”. In the present technology, “r1+r2+r3” is referred to as compression rate information. Note that the brackets shown in Expressions (23) to (27), Expressions (34), (36), (38), (40), (41), (42), (44), (46), and (48), and FIGS. 11 and 13 to be described later represent ceiling functions, and indicate the minimum integer values equal to or greater than the values in the brackets.

[Mathematical Expression 9]

QS₀=(S₀)×2^{┌N/4┐-1} (23)

QS₁=(S₁+a)×2^{┌N/4┐-1}×a (24)

QS₂=(S₂+b)×2^{┌N/4┐-1}×b (25)

QS₃=(S₂+c)×2^{┌N/4┐-1}×c (26)

r=(┌N/4┐+r₁+r₂+r₃)÷N≤1 (27)

FIG. 11 shows the first quantization operation, along with a conventional operation. In the conventional quantization, for each of the Stokes parameters S₀, S1, S2, and S3, a minimum integer equal to or greater than (N/4) is set as allocated bits, and the quantized polarization information indicating a Stokes vector has “N bits”. However, according to the first quantization operation, r₁ bits are assigned to the Stokes parameter S₁, r₂ bits are assigned to the Stokes parameter S₂, and r₃ bits are assigned to the Stokes parameter S₃. Further, since the compression rate r is “1” or lower as shown in Expression (27), the quantized polarization information can compress a larger number of bits more than in the conventional case, with the same resolution as that in the conventional case.

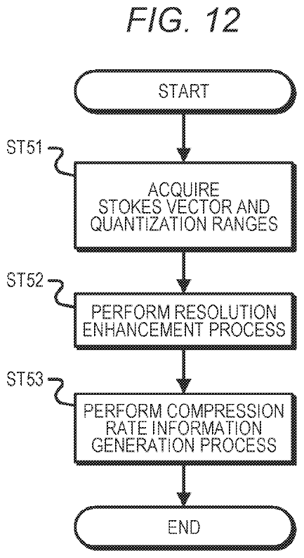

In a second quantization operation, quantization is performed, with priority given to enhancement of resolution rather than reduction of the data amount. Specifically, a resolution increase rate is calculated on the basis of the compression rate indicating the ratio of a calculated quantization bit number to a predetermined quantization bit number, and the quantization bit number for each Stokes parameter is expanded with the resolution increase rate to perform quantization. FIG. 12 is a flowchart showing a second quantization operation. In step ST51, the quantization unit acquires a Stokes vector and its quantization ranges. The quantization unit 32 acquires a Stokes vector from the Stokes vector calculation unit 20, and the quantization ranges from the quantization range setting unit 31, and then moves on to step ST52.

In step ST52, the quantization unit performs a resolution enhancement process. The quantization unit 32 quantizes the Stokes parameter S0 on the basis of Expression (28) using a resolution increase rate β, to generate a quantized parameter QS0. Using the resolution increase rate and the range values a, b, and c of the quantization ranges set by the quantization range setting unit 31, the quantization unit 32 also quantizes the Stokes parameters S1, S2, and S3 on the basis of Expressions (29), (30), and (31), to generate quantized parameters QS1, QS2, and QS3. Note that the resolution increase rate β is the value calculated on the basis of Expression (32) using the compression rates r1, r2, and r3 and the numbers of bits N allocated to the respective Stokes parameter.

$$\begin{matrix}[ Mathematical Expression 10 ] & \\ {QS}_{0} = ( {S}_{0} ) \times {2}^{⌈ N / 4 ⌉ - 1} \times β & ( 28 )\end{matrix}$$

$${QS}_{1} = ( {S}_{1} + a ) \times {2}^{⌈ N / 4 ⌉ - 1} \times a β \qquad ( 29 )$$

$${QS}_{2} = ( {S}_{2} + b ) \times {2}^{⌈ N / 4 ⌉ - 1} \times b β \qquad ( 30 )$$

$${QS}_{3} = ( {S}_{2} + c ) \times {2}^{⌈ N / 4 ⌉ - 1} \times c β \qquad ( 31 )$$

$$β = \frac{N}{⌈ N / 4 ⌉ + {r}_{1} + {r}_{2} + {r}_{3}} \qquad ( 32 )$$

In step ST53, the quantization unit performs a compression rate information generation process. The quantization unit 32 generates the above-described compression rate information so that the resolution increase rate β can be calculated when encoded information is decoded. The quantization unit 32 also sets the allocated bit number RJ of the compression rate information as the bit number shown in Expression (33).

[Mathematical Expression 11]

RJ=┌log₂┌3N/4┐┐ (33)

FIG. 13 shows the second quantization operation, along with a conventional operation. In the conventional quantization, for each of the Stokes parameters S₀, S1, S2, and S3, a minimum integer equal to or greater than (N/4) is set as allocated bits, and the quantized polarization information indicating a Stokes vector has “N bits”. However, according to the second quantization operation, a minimum integer equal to or greater than (βr₀) is set as the number of bits to be allocated to the Stokes parameter S₀, a minimum integer equal to or greater than (βr₁) is set as the number of bits to be allocated to the Stokes parameter S₁, a minimum integer equal to or greater than (βr₂) is set as the number of bits to be allocated to the Stokes parameter S₂, and a minimum integer equal to or greater than (βr₃) is set as the number of bits to be allocated to the Stokes parameter S₃, and the quantized polarization information is designed to have N bits. Accordingly, the quantized polarization information can have a higher resolution than that in the conventional case, with the same number of bits as that in the conventional case. Further, in a case where the resolution is enhanced, the quantized polarization information includes compression rate information of the number of bits RJ. The compression rate information is only required to be obtained at the time of inverse quantization of the Stokes parameters S₀, S1, S2, and S3, and may be provided at a position before the Stokes parameters S1, S2, and S3, for example. Further, in the quantized polarization information, the resolution increase rate β may be set so that the number of bits including the compression rate information becomes N bits.

### <2-5. Operation of the Decoder>

Next, an operation of the decoder is described. Note that the description below is a description of a case where reduction of the data amount or enhancement of resolution can be selected in generation of quantized polarization information.

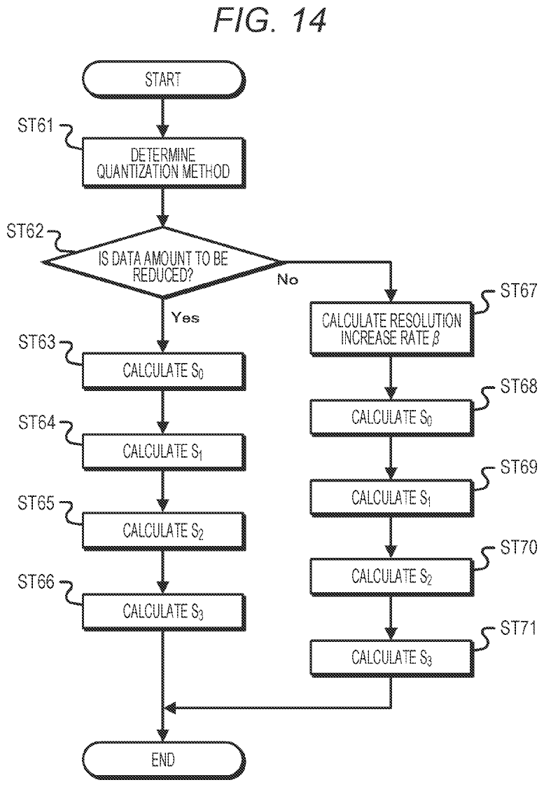

FIG. 14 is a flowchart showing an operation of the decoder. In step ST61, the decoder determines a quantization method. The decoder 40 determines whether the quantized polarization information has been generated by an encoding method with emphasis on reduction of the data amount, or whether the quantized polarization information has been generated by an encoding method with emphasis on enhancement of resolution. The resolution determination unit 41 determines whether the encoding method puts emphasis on reduction of the data amount, or whether the encoding method puts emphasis on enhancement of resolution, on the basis of a mode flag indicated in the header or the like of the stream of the quantized polarization information, for example, and then moves on to step ST62.

In step ST62, the decoder determines whether emphasis is on reduction of the data amount. If the determination result of step ST61 is a quantization method with emphasis on reduction of the data amount, the decoder 40 moves on to step ST63. If the determination result is a quantization method with emphasis on enhancement of resolution, the decoder 40 moves on to step ST67.

In step ST63, the decoder calculates the Stokes parameter S0. The decoder 40 performs calculation according to Expression (34) using the quantized parameter QS0 indicated by the quantized polarization information, calculates the Stokes parameter S0, and then moves on to step ST64.

$$\begin{matrix}[ Mathematical Expression 12 ] & \\ {S}_{0} = \frac{{QS}_{0}}{{2}^{⌈ N / 4 ⌉ - 1}} & ( 34 )\end{matrix}$$

In step ST64, the decoder calculates the Stokes parameter S1. The decoder 40 calculates the range value a, on the basis of Expression (35) using the Stokes parameter S0. Further, the decoder 40 performs calculation according to Expression (36) using the range value a and the quantized parameter QS1 indicated by the quantized polarization information, calculates the Stokes parameter S1, and then moves on to step ST65.

$$\begin{matrix}[ Mathematical Expression 13 ] & \\ a = min ( {S}_{0} , 2 - {S}_{0} ) & ( 35 )\end{matrix}$$

$${S}_{1} = \frac{{QS}_{1}}{{2}^{⌈ N / 4 ⌉ - 1} \times a} - a \qquad ( 36 )$$

In step ST65, the decoder calculates the Stokes parameter S2. The decoder 40 calculates the range value b, on the basis of Expression (37) using the Stokes parameters S0 and S1. Further, the decoder 40 performs calculation according to Expression (38) using the range value b and the quantized parameter QS2 indicated by the quantized polarization information, calculates the Stokes parameter S2, and then moves on to step ST66.

$$\begin{matrix}[ Mathematical Expression 14 ] & \\ b = min ( {S}_{0} , 2 - {S}_{0} , \sqrt{{S}_{0}^{2} - {S}_{1}^{2}} ) & ( 37 )\end{matrix}$$

$${S}_{2} = \frac{{QS}_{2}}{{2}^{⌈ N / 4 ⌉ - 1} \times b} - b \qquad ( 38 )$$

In step ST66, the decoder calculates the Stokes parameter S3. The decoder 40 calculates the range value c, on the basis of Expression (39) using the Stokes parameters S0, S1, and S2. Further, the decoder 40 performs calculation according to Expression (40) using the range value c and the quantized parameter QS3 indicated by the quantized polarization information, and calculates the Stokes parameter S3.

$$\begin{matrix}[ Mathematical Expression 15 ] & \\ c = min ( {S}_{0} , 2 - {S}_{0} , \sqrt{{S}_{0}^{2} - {S}_{1}^{2} - {S}_{2}^{2}} ) & ( 39 )\end{matrix}$$

$${S}_{3} = \frac{{QS}_{3}}{{2}^{⌈ N / 4 ⌉ - 1} \times c} - c \qquad ( 40 )$$

When moving from step ST62 on to step ST67, the decoder 40 calculates the resolution increase rate β on the basis of Expression (41), and then moves on to step ST68. Note that, in Expression (41), the compression rate addition value is included in the quantized polarization information by the number of bits indicated in Expression (33).

$$\begin{matrix}[ Mathematical Expression 16 ] & \\ β = \frac{N}{⌈ N / 4 ⌉ + {r}_{1} + {r}_{2} + {r}_{3}} & ( 41 )\end{matrix}$$

In step ST68, the decoder calculates the Stokes parameter S0. The decoder 40 performs calculation according to Expression (42) using the resolution increase rate β calculated in step ST67 and the quantized parameter QS0 indicated by the quantized polarization information, calculates the Stokes parameter S0, and then moves on to step ST69.

$$\begin{matrix}[ Mathematical Expression 17 ] & \\ {S}_{0} = \frac{{QS}_{0}}{{2}^{⌈ N / 4 ⌉ - 1} \times β} & ( 42 )\end{matrix}$$

In step ST69, the decoder calculates the Stokes parameter S1. The decoder 40 calculates the range value a, on the basis of Expression (43) using the Stokes parameter S0. Further, the decoder 40 performs calculation according to Expression (44) using the range value a, the resolution increase rate β, and the quantized parameter QS1 indicated by the quantized polarization information, calculates the Stokes parameter S1, and then moves on to step ST70.

$$\begin{matrix}[ Mathematical Expression 18 ] & \\ a = min ( {S}_{0} , 2 - {S}_{0} ) & ( 43 )\end{matrix}$$

$${S}_{1} = \frac{{QS}_{1}}{{2}^{⌈ N / 4 ⌉ - 1} \times a β} - a \qquad ( 44 )$$

In step ST70, the decoder calculates the Stokes parameter S2. The decoder 40 calculates the range value b, on the basis of Expression (45) using the Stokes parameters S0 and S1. Further, the decoder 40 performs calculation according to Expression (46) using the range value b, the resolution increase rate β, and the quantized parameter QS2 indicated by the quantized polarization information, calculates the Stokes parameter S2, and then moves on to step ST71.

$$\begin{matrix}[ Mathematical Expression 19 ] & \\ b = min ( {S}_{0} , 2 - {S}_{0} , \sqrt{{S}_{0}^{2} - {S}_{1}^{2}} ) & ( 45 )\end{matrix}$$

$${S}_{2} = \frac{{QS}_{2}}{{2}^{⌈ N / 4 ⌉ - 1} \times b β} - b \qquad ( 46 )$$

In step ST71, the decoder calculates the Stokes parameter S3. The decoder 40 calculates the range value c, on the basis of Expression (47) using the Stokes parameters S0, S1, and S2. Further, the decoder 40 performs calculation according to Expression (48) using the range value c, the resolution increase rate β, and the quantized parameter QS3 indicated by the quantized polarization information, and calculates the Stokes parameter S3.

$$\begin{matrix}[ Mathematical Expression 19 ] & \\ c = min ( {S}_{0} , 2 - {S}_{0} , \sqrt{{S}_{0}^{2} - {S}_{1}^{2} - {S}_{2}^{2}} ) & ( 45 )\end{matrix}$$

$${S}_{3} = \frac{{QS}_{3}}{{2}^{⌈ N / 4 ⌉ - 1} \times c β} - c \qquad ( 46 )$$

Through such a process, the quantized polarization information can be decoded to obtain the Stokes parameters S0, S1, S2, and S3 before quantization.

### <2-6. Other Configurations and Operations>

In the configurations and operations described above, a Stokes vector is calculated using observation luminance obtained by the polarization imaging unit that include no color filters, but the polarization imaging unit may include color filters. In this case, the signal processing device performs the above encoding operation and the above decoding operation for each color.

Further, when a quantization range and a bit number are set for a specific color, and an encoding operation using the quantization range and the bit number set for the specific color is performed for the other colors, the quantized polarization information can be efficiently generated. As for the specific color, in a case where the color array of the color filter is the Bayer array, for example, green having a large number of pixels is set as the specific color. Further, in a case where priority is given to reduction of the data amount, a color having the highest compression rate r may be set as the specific color. In a case where priority is given to enhancement of resolution, a color having the highest resolution increase rate β may be set as the specific color. Furthermore, the specific color is not necessarily set in accordance with these setting criteria, but may be set on the basis of other setting criteria.

Meanwhile, in a case where the characteristics that can be observed by the polarization imaging unit is limited to the characteristics related to linear polarization, information indicating the observation luminance IR of the right circularly polarized light and the observation luminance IL of the left circularly polarized light cannot be generated. In such a case, the encoder 30 generates the quantized polarization information on the basis of the Stokes parameters S₀, S₁, and S₂, and the decoder 40 decodes the quantized polarization information and outputs the Stokes parameters S₀, S₁, and S₂.

### 3. Example Applications

The technology according to the present disclosure can be applied in various fields. For example, the technology according to the present disclosure may be embodied as a device mounted on any type of mobile structure, such as an automobile, an electrical vehicle, a hybrid electrical vehicle, a motorcycle, a bicycle, a personal mobility device, an airplane, a drone, a vessel, or a robot. Also, the technology according to the present disclosure may be realized as a device mounted on a machine that is used in a production process at a factory or on a machine that is used in construction fields. Further, the technology can be applied in fields such as medical fields and public services.

When the technology is applied in such fields, in a case where generation of normal information, separation of reflection components, and the like are performed with polarization information, even if the polarization imaging unit that acquires the polarization information and the polarization information using unit that performs various kinds of processing, control, and the like on the basis of the polarization information are separated, it is possible to transmit the polarization information in a shorter time or with higher resolution than in conventional cases. Also, in a case where various kinds of processing and the like are performed offline on the basis of the polarization information, it is possible to record the polarization information on a recording medium or the like with a smaller amount of data or higher resolution than in conventional cases.

The series of processes described in this specification can be performed by hardware, software, or a combination of hardware and software. In a case where processes are performed by software, a program in which the process sequences are recorded is installed in a memory incorporated into specialized hardware in a computer. Alternatively, the processes can be performed by installing the program into a general-purpose computer that can perform various kinds of processes.

For example, the program can be recorded beforehand in a recording medium, such as a hard disk, a solid state drive (SSD), or a read only memory (ROM). Alternatively, the program can be temporarily or permanently stored (recorded) in a removable recording medium, such as a flexible disk, a compact disc read only memory (CD-ROM), a magneto-optical (MO) disk, a digital versatile disc (DVD), a Blu-ray Disc (BD) (registered trademark), a magnetic disk, or a semiconductor memory card. Such a removable recording medium can be provided as so-called packaged software.

Also, the program may be installed into a computer from a removable recording medium, or may be transferred to a computer from a download site via a network such as a local area network (LAN) or the Internet in a wireless or wired manner. A computer receives the program transferred in such a manner, and installs the program into a recording medium such as an internal hard disk.

Note that the advantageous effects described in this specification are merely examples, and the advantageous effects of the present technology are not limited to them and may include additional effects that are not described herein. Furthermore, it should also be noted that the present technology should not be interpreted to be limited to the above described embodiments of a technology. The embodiments of this technology disclose the present technology through examples, and it should be obvious that those skilled in the art can modify or replace those embodiments with other embodiments without departing from the scope of the technology. That is, the claims should be taken into account in understanding the subject matter of the present technology.

Further, a signal processing device according to the present technology can also have the following configurations.

(1) A signal processing device including

a processing unit that performs a quantization process on a Stokes parameter or an inverse quantization process on the Stokes parameter quantized, on the basis of a quantization range set for each Stokes parameter in accordance with a constraint condition regarding the Stokes parameter and a quantization bit number calculated for each Stokes parameter in accordance with the set quantization range.

(2) The signal processing device according to (1), in which the quantization range is set for the Stokes parameter indicating intensity, and is then set for other Stokes parameters.

(3) The signal processing device according to (2), in which the quantization ranges of the other Stokes parameters are set in descending order of value.

(4) The signal processing device according to (3), in which the quantization range of the Stokes parameter indicating a difference in circularly polarized light is set after the other Stokes parameters.

(5) The signal processing device according to any one of (1) to (4), in which the Stokes parameter indicating intensity has a predetermined quantization bit number, and quantization bit numbers of the other Stokes parameters are calculated on the basis of the predetermined quantization bit number and the quantization range set for each Stokes parameter.

(6) The signal processing device according to any one of (1) to (5), in which a resolution increase rate is calculated on the basis of a compression rate indicating a ratio of the quantization bit number to the predetermined quantization bit number, and the quantization bit number for each Stokes parameter is expanded at the resolution increase rate.

(7) The signal processing device according to any one of (1) to (6), further including

a quantization range setting unit that sets the quantization range for each Stokes parameter,

in which the processing unit generates quantized polarization information by setting the Stokes parameters to quantization bit numbers of the respective Stokes parameters in accordance with the quantization ranges set by the quantization range setting unit.

(8) The signal processing device according to any one of (1) to (5), further including

a quantization range setting unit that sets the quantization ranges of the other Stokes parameters, on the basis of a Stokes parameter obtained by the processing unit performing an inverse quantization process on the quantized polarization information,

in which the processing unit performs an inverse quantization process on the other Stokes parameters, using the quantization ranges set by the quantization range setting unit.

(9) The signal processing device according to (8), further including

a resolution determination unit that calculates a resolution increase rate from the quantized polarization information,

in which the processing unit performs an inverse quantization process on the Stokes parameter, using the resolution increase rate calculated by the resolution determination unit.

### REFERENCE SIGNS LIST

10 System
20 Stokes vector calculation unit
30 Encoder
31, 43 Quantization range setting unit
32 Quantization unit
40 Decoder
42 Resolution determination unit
42 Inverse quantization unit
50 Recording medium
60 Transmission channel

1. A signal processing device comprising
a processing unit that performs a quantization process on a Stokes parameter or an inverse quantization process on the Stokes parameter quantized, on a basis of a quantization range set for each Stokes parameter in accordance with a constraint condition regarding the Stokes parameter and a quantization bit number calculated for each Stokes parameter in accordance with the set quantization range.

2. The signal processing device according to claim 1, wherein
the quantization range is set for the Stokes parameter indicating intensity, and is then set for other Stokes parameters.

3. The signal processing device according to claim 2, wherein
the quantization ranges of the other Stokes parameters are set in descending order of value.

4. The signal processing device according to claim 3, wherein
the quantization range of the Stokes parameter indicating a difference in circularly polarized light is set after the other Stokes parameters.

5. The signal processing device according to claim 1, wherein
the Stokes parameter indicating intensity has a predetermined quantization bit number, and quantization bit numbers of the other Stokes parameters are calculated on a basis of the predetermined quantization bit number and the quantization range set for each Stokes parameter.

6. The signal processing device according to claim 1, wherein
a resolution increase rate is calculated on a basis of a compression rate indicating a ratio of the quantization bit number to the predetermined quantization bit number, and the quantization bit number of each Stokes parameter is expanded at the resolution increase rate.

7. The signal processing device according to claim 1, further comprising
a quantization range setting unit that sets the quantization range for each Stokes parameter,
wherein the processing unit generates quantized polarization information by setting the Stokes parameters to quantization bit numbers of the respective Stokes parameters in accordance with the quantization ranges set by the quantization range setting unit.

8. The signal processing device according to claim 1, further comprising
a quantization range setting unit that sets the quantization ranges of the other Stokes parameters, on a basis of a Stokes parameter obtained by the processing unit performing an inverse quantization process on the quantized polarization information,
wherein the processing unit performs an inverse quantization process on the other Stokes parameters, using the quantization ranges set by the quantization range setting unit.

9. The signal processing device according to claim 8, further comprising
a resolution determination unit that calculates a resolution increase rate from the quantized polarization information,
wherein the processing unit performs an inverse quantization process on the Stokes parameter, using the resolution increase rate calculated by the resolution determination unit.

10. A signal processing method comprising
performing a quantization process on a Stokes parameter or an inverse quantization process on the Stokes parameter quantized, on a basis of a quantization range set for each Stokes parameter in accordance with a constraint condition regarding the Stokes parameter and a quantization bit number calculated for each Stokes parameter in accordance with the set quantization range, the quantization process or the inverse quantization process being performed by a processing unit.

11. A program for causing a computer to perform a quantization process or an inverse quantization process on a Stokes parameter,
the program causing the computer to carry out:
the step of setting a quantization range for each Stokes parameter on a basis of a constraint condition regarding the Stokes parameter;
the step of calculating a quantization bit number for each Stokes parameter in accordance with the set quantization range; and
the step of performing a quantization process on the Stokes parameter, or an inverse quantization process on the Stokes parameter quantized, on a basis of the quantization range and the quantization bit number.
